(19) United States
(12) Patent Application Publication
(10) Pub. No.: US 2026/0119985 A1
(43) Pub. Date: Apr. 30, 2026

(54) CALIBRATING CONFIDENCE SCORES OF PREDICTIVE OUTPUTS

(71) Applicant: SAP SE, Walldorf (DE)

(72) Inventor: Chinmay Kakatkar, Munich (DE)

(21) Appl. No.: 19/037,754

(22) Filed: Jan. 27, 2025

Related U.S. Application Data
(63) Continuation of application No. 18/933,041, filed on Oct. 31, 2024.

(51) Int. Cl. G06N 20/00

(52) U.S. Cl. CPC G06N 20/00

(57) ABSTRACT

Methods, systems, and apparatus, including medium-encoded computer program products, for calibrating model confidence scores, include: providing a set of input datasets to a machine learning model to generate a set of predictions; determining a set of actual observations associated with the set of generated predictions; generating a calibration plot for performance accuracy of the machine learning model based on the set of input datasets; deriving, based on the calibration plot, a best-fit function to predict model accuracy of the machine learning model as a function of confidence scores; generating a composite function to generate an adjusted confidence score for the machine learning model based on a model confidence score of the machine learning model and the predicted model accuracy of the machine learning model; and evaluating a prediction generated by the machine learning model by comparing a confidence score generated for the prediction with the adjusted confidence score.

### CLAIM OF PRIORITY

This application claims priority under 35 USC § 120 to U.S. patent application Ser. No. 18/933,041, filed on Oct. 31, 2024, titled “CALIBRATING CONFIDENCE SCORES OF PREDICTIVE OUTPUTS” (Attorney Docket No.: 22135-1860001/240581US02), the entire contents of which are hereby incorporated by reference.

### TECHNICAL FIELD

The present disclosure relates to computer-implemented methods, software, and systems for data processing.

### BACKGROUND

Software applications can provide services and access resources. Software applications can provide services to end users and expose interfaces that allow for user interaction and data input. Software applications can store obtained data from users, for example, in tabular format at data stores. Tabular data can be organized in rows and columns, where each row can represent a record of data associated with a data object such as an entity, an order, an executed task, etc. Each column in tabular data can represent a specific attribute, property or variable related to the record.

Machine learning models can be used to assist in the filling of user interface forms, where an output of a machine learning model can be used to predict a data record based on past data records input to a particular field and based on data records input into other fields of a user interface form. In some cases, an output of the machine learning model is characterized by an uncalibrated confidence score that does not relate to an accuracy of the output of the machine learning model.

### SUMMARY

The present disclosure describes mechanisms to implement a calibration of model confidence scores of a machine learning model.

In a first aspect, the subject matter described in this specification can be embodied in one or more methods (and also one or more non-transitory computer-readable mediums tangibly encoding a computer program operable to cause data processing apparatus to perform operations, including: providing a set of input datasets to a machine learning model to generate a set of predictions for each input dataset; determining a set of actual observations associated with the set of generated predictions for the set of input datasets, wherein each of the set of generated predictions is associated with a corresponding confidence score; generating a calibration plot for performance accuracy of the machine learning model based on the set of input datasets, wherein the calibration plot maps i) a confidence score for a prediction to ii) a correspond model accuracy corresponding to the prediction as determined based on an actual observation of the set of actual observation; deriving, based on the calibration plot, a best-fit function to predict model accuracy of the machine learning model as a function of confidence scores; generating a composite function to generate an adjusted confidence score for the machine learning model based on a model confidence score of the machine learning model and the predicted model accuracy of the machine learning model; and evaluating a prediction generated by the machine learning model by comparing a confidence score generated for the prediction with the adjusted confidence score.

In a second aspect, the subject matter described in this specification can be embodied in one or more methods (and also one or more non-transitory computer-readable mediums tangibly encoding a computer program operable to cause data processing apparatus to perform operations, including: determining a first confidence score for a prediction generated by a machine learning model; applying a threshold-setting function to determine a confidence threshold by comparing the determined first confidence score with a reference confidence score of the machine learning model, wherein the threshold-setting function determines the confidence threshold to a lower or higher value based on determining whether the reference confidence score is below or above the first confidence score; and generating a prediction evaluation of the prediction generated by the machine learning model by comparing the first confidence score with the confidence threshold.

The described subject matter of the first and second aspects can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. In accordance with implementations of the present disclosure, outputs of a machine learning model can be accurately evaluated based on a calibrated confidence score. The calibrated confidence score provides an evaluation that more closely reflects a linear probability of correctness, resulting in a more interpretable evaluation of the prediction compared to an evaluation based on an uncalibrated confidence score. As such, fewer computational resources (e.g., compute cycles) are required for training the machine learning model to achieve an output accuracy above a threshold.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 depicts an example system in accordance with implementations of the present disclosure.

FIG. 2 is a plot illustrating an example relationship between a model confidence score and a model accuracy associated with outputs of a machine learning model.

FIG. 3 is a block diagram illustrating an example of a computer-implemented system for generating a calibrated confidence score of a prediction of a machine learning model with a composite function, according to an implementation of the present disclosure.

FIG. 4 is a flowchart illustrating an example of a computer-implemented method for providing a calibrated confidence score of a prediction of a machine learning model based on using a composite function, according to an implementation of the present disclosure.

FIG. 5 is a block diagram illustrating an example of a computer-implemented system for generating a calibrated confidence score of a prediction of a machine learning model with a threshold-setting function, according to an implementation of the present disclosure.

FIG. 6 is a flowchart illustrating an example of a computer-implemented method for providing a calibrated confidence score of a prediction of a machine learning model based on using a threshold-setting function, according to an implementation of the present disclosure.

FIG. 7A is a block diagram illustrating an example user interface form provided for user interaction and input of field values at one or more fields, according to an implementation of the present disclosure.

FIG. 7B is a block diagram illustrating an example user interface form provided for user interaction that implements logic for automatic data imputation based on a trained model, according to an implementation of the present disclosure.

FIG. 8 is a block diagram illustrating an example of a computer-implemented system for calibrating a confidence score of a prediction of a machine learning model, according to an implementation of the present disclosure.

FIG. 9 is a block diagram illustrating an example of a computer-implemented system for calibrating a confidence score of a prediction of a machine learning model, according to an implementation of the present disclosure.

FIG. 10 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes mechanisms for calibrating confidence scores of outputs generated by machine learning models. In some instances, the outputs of machine learning models include data indicative of a prediction. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

A machine learning model can provide predictive outputs based on a previously unseen data set, where the machine learning model is trained on training data with similar attributes as the unseen data. For example, machine learning models can be trained to provide prediction for execution of processes in various contexts including statistical analysis, system performance, or approval processes within a transaction or organizational context, among other examples. In some instances, predictive outputs from machine learning models can be used to improve the speed of process execution within a system environment. For example, a process can be implemented by one or more computer programs, and multiple instances of the process can be executed. Based on collected past observation of the process, a machine learning model can be trained to predict process outputs. The outputs provided by a trained model can include an identification of a data pattern in an input data set, can include a recommendation for performing a given action, or outputting a data value as a prediction, among other examples. Such model outputs can be used to automate the process execution and thus be performed with fewer resource requirements including computation resources, resources to interact with users or other entities, processing power, as well as time.

For example, an application can expose a user interface form(s) that includes fields that can be filled in by users or through other external input. Filling in data in such user interface forms can be a time-consuming task that is error prone. In some instances, a machine learning model can be trained to provide predicted values that can be input in a user interface form instead of obtaining user's input for those values or other external input. The output of the trained machine learning model can represent a recommendation for a value to be filled in the user interface form. Possible inaccuracies in the data recording or issues upon execution of requests in view of data discrepancy can lead to inefficiency in process and task executions.

In some instances, a predictive output of the machine learning model is associated with a confidence score defined over a scale, for example, a value between 0 and 1. The confidence score that is determined for predictions provided by the machine learning model can be calibrated or uncalibrated. For example, for a given AI model with a calibrated confidence score, a calibrated confidence score of 0.8 can be interpreted that when provided with 100 predictions, it can be expected that approximately 80 samples from the predictions would be correct (e.g., provide a correct classification) by the given AI model. However, in some cases, an AI model may provide predictions associated with uncalibrated confidence scores. In those cases, the confidence score of 0.8 may not give an indication of how certain the model is of their predictions, and as such it may not be expected that 80% of the outputs provided by the AI model would be expected to be accurate. In these cases, outputs provided by the AI model are related to an actual accuracy, as determined by observing the predictions of the AI model in the real use case environment, other than 80%. In some instances, the confidence scores of an AI model can be used to determine an actual accuracy of the AI model if those confidence scores are calibrated. In that case, when the AI model is used in a productive setup, provided predictions by the AI model can be considered to have an expected accuracy corresponding to the calibrated confidence score of the model. If those scores are not calibrated, they may not be a reliable source for the expected accuracy of the AI model. In some instances, the calibrated confidence score can be used to determine if the corresponding predictive output should be used as input for executing a particular process (e.g., used to automate the filling in of data in a user interface), where the use of such predictive output can be determined based on meeting a certain level of expected accuracy of the input data to be provided to the particular process (e.g., above 90% accuracy which can be inferred from 0.9 calibrated confidence score).

In some instances, since an uncalibrated confidence score associated with a predictive output of a machine learning model is not associated with a percentage of expected correct predictions, evaluating accuracy of AI models by relying on confidence scores of different models without being provided with an indication whether those confidence scores are calibrated or not, may not be a reliable evaluation method. In particular, a mismatch between the confidence score associated with the predictive output of the machine learning model and an expected accuracy of the predictive output occurs when the confidence score is uncalibrated.

In view of the possible discrepancy between a confidence score of a predictive output of a machine learning model and an accuracy (i.e., a percentage of instances in which a predictive output is correct) of the machine learning model when the confidence score of the machine learning model is not calibrated, a calibration procedure can be implemented to increase interpretability and efficiency of evaluating predictive outputs of the machine learning model. In some instances, the calibration procedure can rely on calibration according to a composite function, which can correct an imperfect mapping between a confidence score and an accuracy metric. In some instances, the calibration procedure can rely on calibration according to a threshold-setting function, in which a calibration score is mapped to a standard range of values based on a threshold value.

For example, a machine learning model can be used to provide recommendations that can be used as input for executing steps of a process associated with a user interface. The steps can be related to actions including an execution of a transaction, performing a particular task, defining a process, executing a process, among others. In some instances, the machine learning model generates predictive outputs indicative of recommendations for filling in data of a user interface form that is generated to obtain input data to initiate an execution of process (e.g., to prepare a sales order). In some instances, the user interface form can be used to generate instructions for inputting data to initiate a process or provide information to another system.

In the context of providing recommendations for data values of a user interface form, the accuracy of a predictive output for filling in fields can assist a system in determining if the recommendation should be provided to a user. Filling in a form can be performed in the context of a human-computer interaction, where in some instances, a machine learning model can be used in the context of user interface forms, where data and/or values are filled in during a human-computer interaction, where the user provides input data to perform steps of a procedure that requires input and relies on implemented logic (e.g., the machine learning logic) for guiding the user in executing the procedure and providing the relevant data as recommendations or output to automate the process. User interface forms can be associated with storing data in tabular form, and based on such stored tabular data, an inference can be made for recommending field values to be provided for fields where values are missing in accordance with implementations of the present disclosure. To support a user in the tasks of filling in such user interface form, an intelligent inference system can be created that understands specifics of the application and the use of the user interface form so that the user can be provided with recommendations for values to be filled in the user interface form for fields that have not been provided with field values by the user or otherwise (e.g., based on fixed rules) in a more reliable yet efficient manner. In some instances, machine learning models can be evaluated to determine which one to use in the context of automating the process of filling in data in the fields, or machine learning models can be evaluated to determine whether to apply targeted fine-tuning or re-training to adjust the model's logic to provide outputs that are associated with higher accuracy. In some instances, the evaluation of the confidence scores of machine learning models can be performed based on calibration techniques to determine a calibrated confidence score in accordance with the present disclosure.

There are many use cases that benefit from a determination of a calibrated confidence score that represents the accuracy of a trained machine learning model in a particular context. One example is the use case of imputing values in missing fields of a user interface form, where the calibrated confidence score associated with a prediction of the model is used to determine if the corresponding predicted output of the trained model meet a required threshold or characteristic to be utilized in the user interface form. Aside from the example use case of considering calibrated confidence scores associated with predictive outputs of a machine learning model to determine if the corresponding outputs should be used for filling in fields of a user interface form, other example use cases exist. For example, a system can generate automated reports by implementing a trained machine learning model, where calibrated confidence scores can be used to determine if the outputs of the trained machine learning model are acceptable for the use case (e.g., meets a predefined acceptance criteria). Furthermore, similar applications include triggering alarms of a system, where the triggering is in response to receiving an output from a trained machine learning model that can determine a severity of an event to trigger an alarm. In some instances, multiple trained machine learning models may be available for use to provide output that can be included in another process or other execution. In some instances, the calibrated confidence scores can support making a selection of a model from the available models that would provide outputs with highest level of accuracy in the particular context.

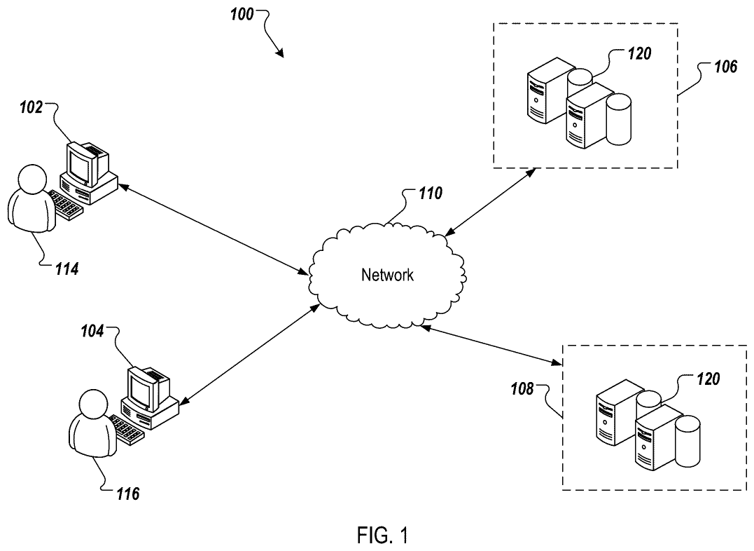

FIG. 1 depicts an example system 100 in accordance with implementations of the present disclosure. In the depicted example, the example system 100 includes a client device 102, a client device 104, a network 110, an environment 106, and an environment 108. The environment 106 and the environment 108 may be cloud environments. The environment 106 and the environment 108 may include corresponding one or more server devices and databases (e.g., processors, memory). In the depicted example, a user 114 interacts with the client device 102, and a user 116 interacts with the client device 104.

In some examples, the client device 102 and/or the client device 104 can communicate with the environment 106 and/or environment 108 over the network 110. The client device 102 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 110 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some instances, the environment 106 includes at least one server and at least one data store 120. In the example of FIG. 1, the environment 106 is intended to represent various forms of servers including, but not limited to a web server, an application server, a proxy server, a network server, and/or a server pool. In general, server systems accept requests for application services and provides such services to any number of client devices (e.g., the client device 102 over the network 110) and other service requests, as appropriate.

In some instances, the environments 106 and 108 may host one or more client applications that can provide user interfaces including user interface forms that implement machine learning techniques described in the present application to support automatic data imputation. In some instances, the environments 106 and 108 may execute operations according to the calibration techniques described in the present application that support a calibration of confidence scores associated with outputs of a trained machine learning model. In some instances, the calibration techniques can include determining an output of a composite function, in which the output of the composite function is indicative of correction to the discrepancy between an uncalibrated confidence score and the accuracy of the model. In some instances, the calibration techniques can include determining an output of a threshold-setting function, in which the output of the threshold-setting function is indicative of a mapping of the uncalibrated confidence score to a pre-determined range of confidence scores.

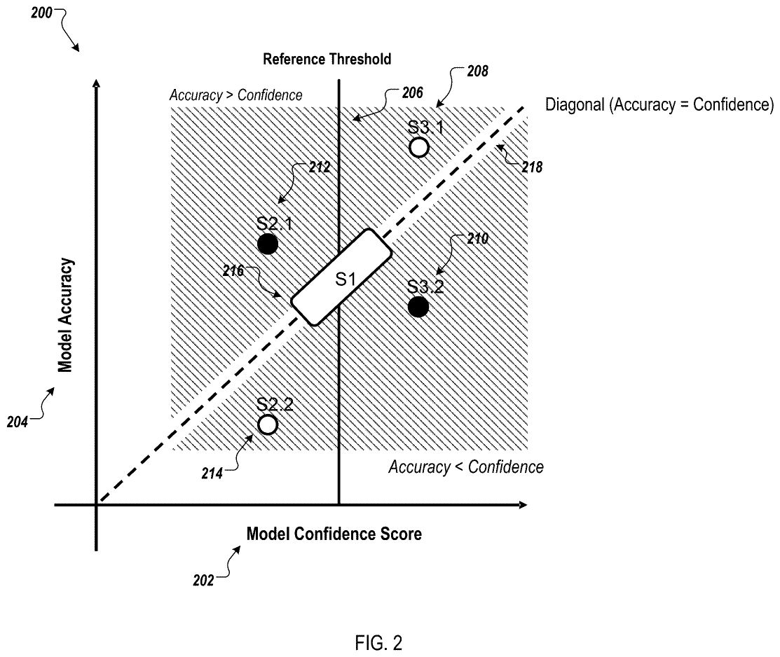

FIG. 2 is a plot 200 illustrating an example relationship between a model confidence score 202 and a model accuracy 204 associated with outputs of a machine learning model. The plot 200 includes a horizontal axis that represents the model confidence score 202 and the model accuracy 204.

The model confidence score 202 is indicative of an expected accuracy of a machine learning model. In some cases, the model confidence score 202 is derived from the model's internal assessment of the likelihood that a given prediction is correct. The method for determining the model confidence score 202 varies depending on the type of model and its underlying algorithm. For example, in some instances that include predicting a classification of an input, the model confidence score 202 can be determined based on a logistic regression function which outputs a set of probabilities which are treated as confidence scores. The logistic regression function generates a value between 0 and 1 representative of how likely the input data belongs to the provided class represented by the output of the machine learning model. For example, an output of 0.9 is not necessarily indicative of a prediction that is 90% accurate. For example, execution of the prediction 100 times does not necessarily yield 90 correct predictions. The confidence score output by a logistic regression is a subjective probability based on the model's internal function and does not necessarily represent accuracy having the same percentage value. For example, a confidence score of 0.9 simply means the model is more confident relative to a confidence score of 0.8.

In some instances, confidence scores for predictive models can be generated by applying a softmax function in the context of a neural network in the output layer of the network. The softmax function converts a raw output (logits) into a probability distribution over all possible output classes. The output of the softmax function for each class if interpreted as a confidence score, but similar to the logistic regression, does not have to correspond to an accuracy value (e.g., represented as a percentage). In summary, the model confidence score 202 represents the internal evaluation of accuracy provided by a particular machine learning model that does not necessarily represent the accuracy of the machine learning model outputs.

The model accuracy 204 of the plot 200 is an evaluation of how often the predictive output of the machine learning model is correct in a true percentage based representation. In other words, the model accuracy 204 represents the percentage of times that the predictive output is correct. If a sample size of 100 predictions are made by the machine learning model, a model accuracy of 0.8 indicates that on average, 80 of the predictions will be correct. In comparison with the model confidence score 202, the model accuracy is not a relative, subjective evaluation of the predictive output, and is therefore a more useful metric for making design choices, determining if outputs should be used in an application, etc.

The plot 200 includes a diagonal line 218 that represents scenarios in which the model confidence score 202 and the model accuracy 204 are perfectly correlated (i.e., the model confidence score is equal to the model accuracy for all values of the model confidence score). The diagonal line 218 represents a scenario of a machine learning model with outputs associated with well-calibrated confidence scores, in which the model confidence score 202 is perfectly correlated with the model accuracy 204. In this case, the model confidence scores 202 that are determined at the time of generating the outputs of the model correspond to the accuracy of those output as determined after verification of those outputs (e.g., based on user verification, observation of events at a productive setup, etc.).

The plot 200 is segmented into two halves around the diagonal line 218. For example, a first half, represented by a first example data point 212 and a second example data point 208, represent scenarios in which a model confidence score is mapped to a higher model accuracy, underestimating the accuracy of the model. For example, the first example data point 212 can indicate a mapping of a model confidence score of 0.4 to a model accuracy of 0.6. In other words, if the model confidence score is interpreted as an expectation of an accuracy (an expected percentage of correct predictions of all the predictions provided by the model), the machine learning model will perform better than expected.

A second half is represented by a third example data point 214 and a fourth example data point 210. The third and fourth example data points 214 and 210 represent scenarios in which a model confidence score is mapped to a lower model accuracy, overestimating the accuracy of the model. For example, the third example data point 214 can indicate a mapping of a model confidence score of 0.4 to a model accuracy of 0.2. In other words, if the model confidence score is interpreted as an expectation of an accuracy, the machine learning model will perform worse than expected.

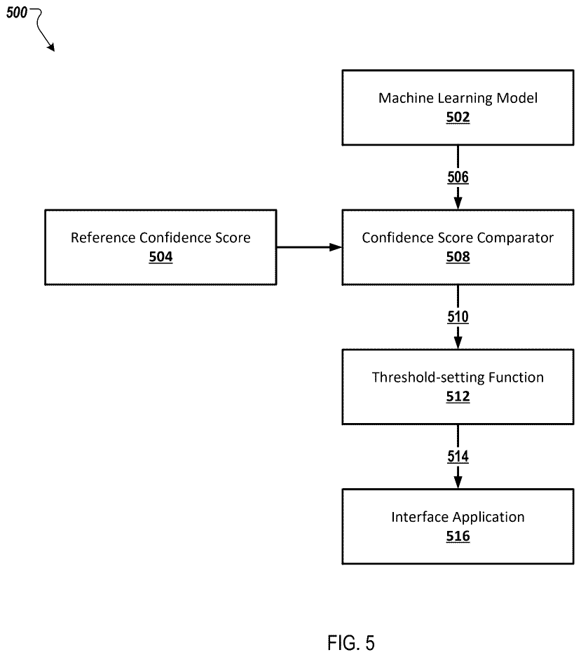

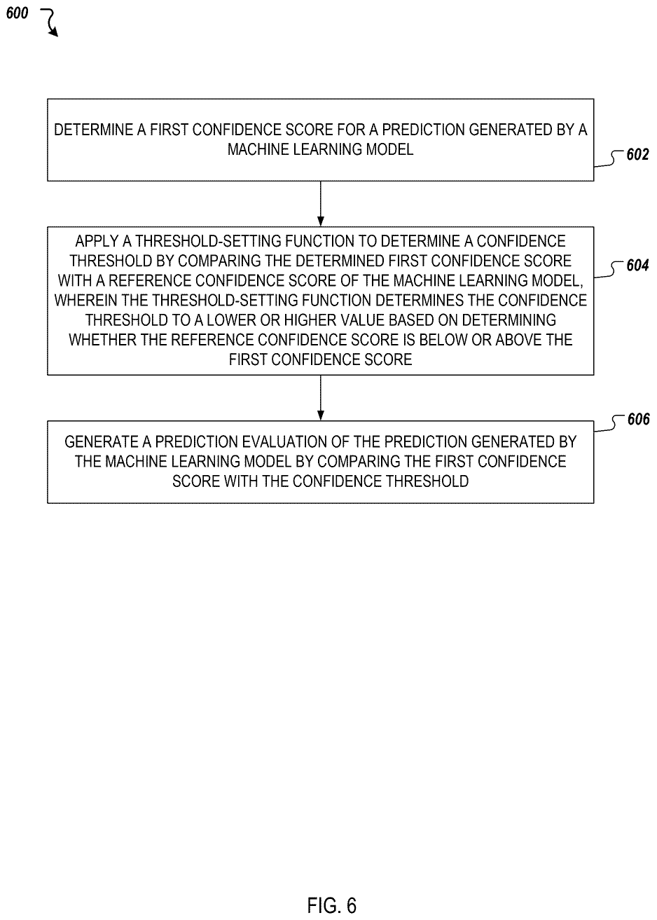

The plot 200 depicts a vertical line indicative of a reference threshold 206. As described in more detail below in relation the descriptions of FIGS. 5-6, a system can apply a threshold function to differentiate between cases in which the model confidence score 202 underestimates the model accuracy 204 of the predictive output from cases in which the model confidence score 202 overestimates the model accuracy 204 of the predictive output.

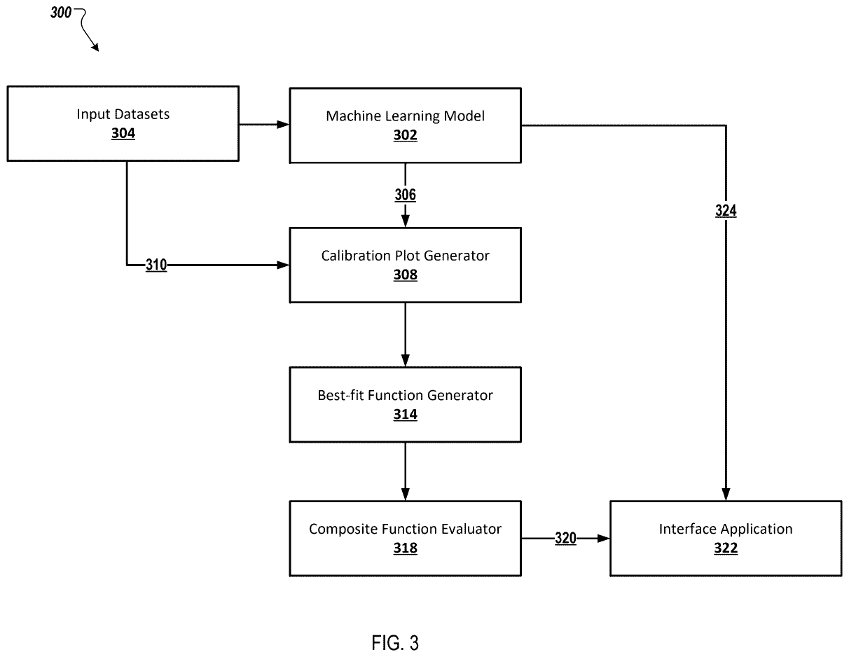

FIG. 3 is a block diagram of an example computer-implemented system 300 for calibrating a confidence score of a predictive output of a machine learning model by evaluating a composite function. The system 300 includes at least one processor (e.g., a processor of a computing device of the environment 106 or 108 of FIG. 1) that implements operations of a machine learning model 302 that generates predictive outputs 306 that include a prediction and a corresponding confidence score. In some instances, the predictions of the predictive outputs 306 correspond to a prediction of a recommended value to be input into a user interface field of a client application (e.g., a client application hosted by the environment 106 or 108 of FIG. 1). The corresponding confidence score of the predictive output 306 can indicate a degree of confidence, based on an internal evaluation of the machine learning model 302, of the prediction. In a general sense, each system component of FIG. 3 represents one or more computational operations executed by a processor of a system, e.g., system 100, that includes one or more processors (e.g., a processor of a computational device of environment 106 or 108, a processor associated with the client device 102, etc.).

The machine learning model 302 processes a set of input datasets 304 to generate a set of predictions for each input dataset. In some instances, as described in relation to the model confidence score 202 described in FIG. 2, the machine learning model 302 generates a predictive output 306 that includes a prediction and a corresponding model confidence score for each prediction related to a particular data item or dataset. In some cases, the model confidence score included in the predictive output 308 cannot be interpreted as a model accuracy in terms of a percent likelihood that the prediction is correct.

The input datasets 304 can include both input data 304 that is processed by the machine learning model 302 and corresponding labeled data 310 that represent actual observations related to the data of the input datasets 304. A calibration plot generator 308 can process a subset of the input datasets 304 as training data to generate a calibration plot. The calibration plot represents a performance relationship related to accuracy of a machine learning model based on the input datasets. The generated calibration plot maps a model confidence score for each prediction of the machine learning model 302 to a model accuracy (as determined based on actual observations) that represents a percentage likelihood of an accurate result. The input datasets 304 provides the input to be processed by the machine learning model 302 and the actual as labeled data 310 that serve as ground truth labels and/or training data labels. The data depicted in the generated calibration plot represent a relationship between model accuracy and model confidence, as generated by the machine learning model 302. In some instances, the machine learning model 302 is executed multiple times for each input model confidence score to get a statistical representation of the model accuracy.

A best-fit function generator 314 processes an output of the calibration plot generator 308 (i.e., the data depicted in the generated calibration plot). The best-fit function generator 314 determines a best-fit function to predict the model accuracy of the machine learning model 302 as a function of a confidence score, as generated by the machine learning model 302.

For example, consider a trained machine learning model that processes a set of input data X and returns a corresponding prediction k of the form (yᵢ, sᵢ), in which yᵢ represents the predictive output of the machine learning model and sᵢ represents the corresponding confidence score. The best-fit function generator 314 can determine a best-fit function ƒ(s)=a, in which s is a processed confidence score to be calibrated and a is the corresponding actual model accuracy as seen in the calibration plot, as generated by the calibration plot generator 308. The determination of the best-fit function attempts to find an analytical representation of the true relationship between model confidence score and model accuracy in relation to the machine learning model. For a perfectly calibrated model (confidence score and accuracy are equivalent), given a confidence score of s_{c}, the corresponding actual model accuracy is a=s_{c}. For an approximately calibrated model (confidence score and accuracy are close, but not equivalent), given a confidence score of s_{c}, a difference between the confidence score and the accuracy can be determined as δ=s−a, which represents the calibration error.

In some instances, the best-fit function generator 314 implements a linear regression, a polynomial regression, a logistic regression, a non-linear regression, or any other method for determining an analytical representation of an empirical relationship between variables. The best-fit function generator 314 outputs a function that represents an observed relationship between the model confidence score and the model accuracy associated with the machine learning model 302. The best-fit function can be provided to support prediction of a model accuracy for any given input model confidence score of that given model.

In some instances, another machine learning model (different from the machine learning model 302) can be configured to predict a calibration error ê by processing an input model confidence score and any other contextual data Z available during the training process of the machine learning model 302. In the context of providing recommendations for imputing values for fields of a user interface form, the values of Z can include a type of customer, sector, cardinality of features of the machine learning model 302, data size, among others. The machine learning model configured to predict the calibration error can be represented as a function δ(s, Z)=ê, where the machine learning model predicts a calibration error between the model confidence score and the model accuracy. The output value of the machine learning model is the difference δ=s−a.

Based on the machine learning model to predict the calibration error, or other representation of the relationship between the model confidence score and the model accuracy as determined by the best-fit function generator 314, a composite function evaluator 318 can determine a value of a composite function. The composite function can be represented as g(s, Z)=s+δ(s, Z)=s_{c}. Given a previously unseen model confidence score related to a prediction of the machine learning model 302 and contextual data Z related to the training of the machine learning model 302, the value of the composite function represents an adjusted (e.g., corrected) confidence score s_{c}, such that s_{c} is approximately equal to a, as depicted by a diagonal line on the calibration plot (the diagonal line 218 of FIG. 2).

In some instances, an interface application 322 receives an adjusted confidence score 320 from the composite function generator 318. In some instances, the interface application 322 can correlate the corresponding predicted output 324 from the machine learning model 302 with the adjusted confidence score 320 to determine if the predicted output 324 should be displayed on an associated user interface or provided to an end user through an application programming interface. In some instances, the interface application 322 displays the adjusted confidence score 320 on an associated user interface. In some instances, the interface application 322 evaluates the prediction 324 generated by the machine learning model 302 by comparing the model confidence score associated with the predictive output 306 with the adjusted confidence score 322. In some cases, the adjusted confidence score 322 is referred to as a calibrated confidence score.

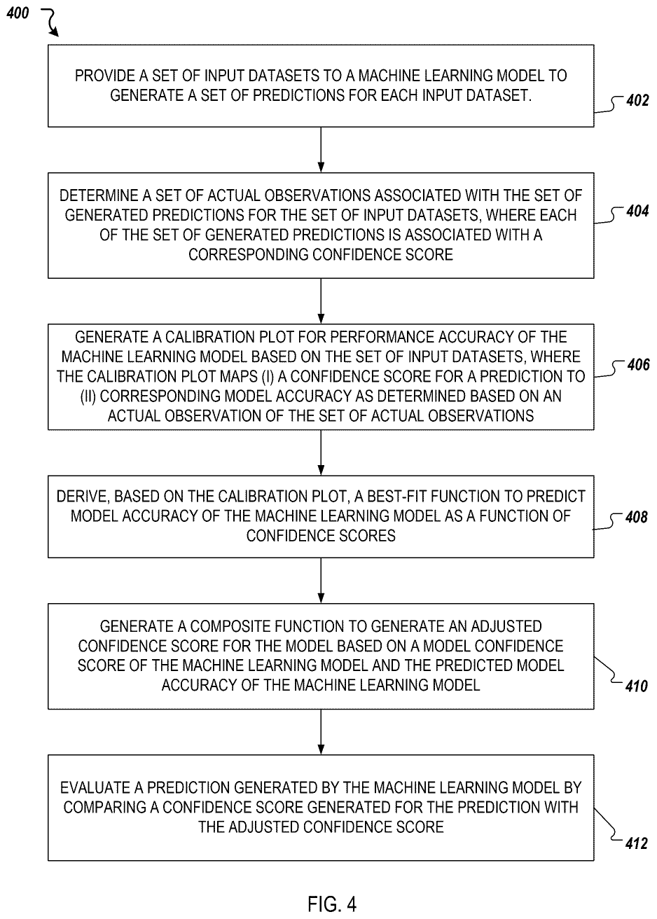

FIG. 4 is a flowchart illustrating an example of a computer-implemented method 300 for providing a calibrated confidence score for a prediction of a machine learning model based on using a composite function, according to an implementation of the present disclosure. For clarity of presentation, the description that follows generally describes method 400 in the context of the other figures in this description. However, it will be understood that method 400 can be performed, for example, by any system, environment, software, and hardware, or a combination of systems, environments, software, and hardware, as appropriate. For example, the method 400 can be performed at a server of environment 106 of FIG. 1. In some implementations, various steps of method 400 can be run in parallel, in combination, in loops, or in any order.

At 402, the system provides a set of input datasets to a machine learning model to generate a set of predictions for each input dataset. The machine learning model generates predictive outputs and provides corresponding confidence scores that are to be calibrated according to the operations of method 400. In some instances, the input datasets includes input data to be processed by the machine learning model and associated labels that are indicative of accurate outputs. In some instances, the machine learning model is trained on one or more subsets of the input datasets.

In some instances, the input datasets are associated with contextual data that describe one or more specific attributes of the input dataset. Contextual data can include specific characteristics of the input dataset related to an application, use case, user, etc., of which the input data set is related. In some instances, the machine learning model processes both the input values of the input datasets and the associated contextual data. In some instances, the contextual data includes customer-specific training data.

At 404, the system determines a set of actual observations associated with the set of generated predictions for the set of input datasets, where each of the set of generated predictions is associated with a corresponding confidence score. As described above, the corresponding confidence score is based on an internal evaluation of how likely the generated prediction is to be true. However, the generated confidence score need not correlate with accuracy as defined as a probability of the prediction being correct in relation to the set of actual observations.

At 406, the system generates a calibration plot for performance accuracy of the machine learning model based on the set of input datasets, wherein the calibration plot maps i) a confidence score for a prediction to ii) a correspond model accuracy corresponding to the prediction as determined based on an actual observation of the set of actual observation. The calibration plot represents the observed relationship between the model accuracy and model confidence score.

At 408, the system derives, based on the calibration plot, a best-fit function to predict the model accuracy of the machine learning model as a function of confidence scores. In some instances, a machine learning technique, e.g., linear regression, support vector machine, neural network, etc., can be implemented to determine an analytical relationship (e.g., coefficient values of a particular analytical function) between the confidence score and accuracy of the machine learning model.

At 410, the system generates a composite function to generate an adjusted confidence score for the model based on a model confidence score of the machine learning model and the predicted model accuracy of the machine learning model. In some instances, the composite function processes the generated model confidence score and relevant contextual data to output an adjusted confidence score that more accurately maps to the accuracy in terms of probability of correctness of the machine learning model.

At 412, the system evaluates a prediction generated by the machine learning model by comparing a confidence score generated for the prediction with the adjusted confidence score. In some instances, the system includes an application interface that is exposed for processing requests for evaluating predictions generated by the machine learning model. The interface receives a request to evaluate a new prediction generated by the machine learning model and provides the adjusted confidence score (i.e., the calibrated confidence score) associated with the new prediction, based on the steps of the method described here.

FIG. 5 is a block diagram of an example computer-implemented system 500 for calibrating a confidence score of a predictive output of a machine learning model by using a threshold-setting function. The system 500 includes at least one processor (e.g., a processor of a computing device of the environment 106 or 108 of FIG. 1) that implements operations of a machine learning model 502 that generates predictive outputs 506 that include a prediction and a corresponding confidence score. In some instances, the predictions of the predictive outputs 506 correspond to a prediction of a value that can be input or provided as a recommendation for input into a user interface field of a client application (e.g., a client application hosted by the environment 106 or 108 of FIG. 1). The corresponding confidence score of the predictive output 506 can indicate a degree of confidence, based on an internal evaluation of the machine learning model 502, of the prediction. In a general sense, each system component of FIG. 5 represents one or more computational operations executed by a processor of a system, e.g., system 100, that includes one or more processors (e.g., a processor of a computational device of environment 106 or 108, a processor associated with the client device 102, etc.).

The machine learning model 502 provides a prediction and an associated confidence score as a predictive output 506 to a confidence score comparator 508. The confidence score comparator 508 processes the confidence score from the machine learning model 502 and a reference confidence score 504 to determine if the received confidence score is greater than, less than, or equal to the reference confidence score 504.

The reference confidence score 504 corresponds to the reference threshold 206 depicted as the vertical line of the plot 200 of FIG. 2. In some instances, the reference confidence score 504 is determined empirically such that preferred scenarios, depicted in plot 200, are more likely to pass a threshold defined by the empirically chosen reference confidence score 504.

Based on the comparison, a threshold-setting function 512 is executed to define a confidence threshold that can be used to calibrate the model confidence score 504 by comparing the reference confidence score 504 with the confidence threshold. The threshold-setting function sets the confidence threshold to a lower or higher value based on determining if the confidence score of the predictive output 506 is below or above the reference confidence score 504. For example, the reference confidence score 504 can be empirically determined from past executions of the model, where predicted accuracy through confidence scores can be compared with real-time verified accuracy of the generated outputs. For example, the reference confidence score 504 can be determined through experiments to be 0.5. If the confidence score for a given generated prediction is determined to be higher than the reference confidence score 504 (e.g., 0.6), the confidence threshold can be set to a higher score than 0.5. That confidence threshold can be used to evaluate whether to accept or reject the use of a provided prediction from the model. By adjusting the confidence threshold, to a lower or a higher value, the confidence threshold can be used as a calibrated confidence score so that worse-than-expected predictions are filtered out.

For example, a scenario (represented by data point 212 of plot 200) in which the machine learning model 502 generates better-than-expected predictions occurs when a confidence score is mapped to a model accuracy that is higher. However, in this scenario, and with reference to the represented plot 200 with data points as shown and described in relation to FIG. 2, the example data point 212 is less than the reference confidence score 504, and in some instances, is not provided to a user. In some cases, this negatively impacts user experience, because the prediction associated with the generated confidence score is more accurate than what the confidence score represents and is not provided as an output.

As another example, a scenario (represented by data point 210 of plot 200) in which the machine learning model 502 generates a worse-than-expected prediction occurs when a confidence score is mapped to a model accuracy that is lower. In this scenario, the example data point 210 is greater than the reference confidence score 504, and in some instances, is provided to a user. In some cases, this negatively impacts user experience, because the prediction associated with the generated confidence score is less accurate than what the confidence score represents and is still provided as an output.

As another example, a scenario (represented by data point 208 of plot 200) in which the machine learning model 502 generates a better-than-expected prediction and the associated prediction is provided as output because the data point 208 is greater than the reference confidence score 504. This does not negatively impact user experience because the predicted output is more accurate than expected.

As another example, a scenario (represented by data point 214 of plot 200) in which the machine learning model 502 generates a worse-than-expected prediction and the associated prediction is provided as output because the data point 208 is less than the reference confidence score 504. This does not negatively impact user experience because the predicted output is less accurate than expected, but it is not provided as output.

To empirically determine an optimal value of the reference confidence score 504, the scenarios corresponding to the example data points 208 and 214 of plot 200 should be more common than the other two scenarios.

For example, to minimize the scenarios associated with the example data point 212 which suppresses predictive outputs associated with better-than-expected accuracies, the reference confidence score 504 can be set to a low value to ensure that better-than-expected predictions are provided. As another example, to maximize the scenarios associated with the example data point 210, the reference confidence score 504 can be set to a high value to ensure that worse-than-expected predictions are not provided. However, scenarios represented by the example data point 212 are more likely for a low reference confidence score 504 and scenarios represented by the example data point 210 are less likely for a low reference confidence score 504. An optimized, reference confidence score (μ*) for the threshold function can be empirically determined such that scenarios represented by the example data point 212 are likely to occur to the left of μ* and scenarios represented by the example data point 210 are likely to occur to the right of μ*. A suitable threshold function can be determined and expressed as

$$σ ( μ , {μ}^{*} , {θ}_{L} , {θ}_{H} ) = \{ \begin{matrix}{θ}_{L} , & μ \leq {μ}^{*} \\ {θ}_{H} , & μ > {μ}^{*}\end{matrix} .$$

In comparison with other methods for calibrating confidence scores, the threshold-setting method is more cost effective, fast, and simple to implement.

In some instances, a reference confidence score (μ*) for a machine learning model can be determined empirically based on processing historical data associated with past executions of the machine learning model. The historical data includes multiple predictions and respective confidence scores generated by the machine learning model. The predictions and respective confidence scores can be compared to observed outcome values to compute an accuracy of the predictions of the machine learning model. The historical data can be analyzed to determine the reference confidence score for the model, as well as the low and high threshold values, based on the comparison between the confidence scores for the predictions and the observed outcome values (those indicate the actual accuracy of the model determined in a productive context).

In some instances, a plot (e.g., the example plot 200 of FIG. 2) can be generated based on the predictions with respective confidence scores and the observed outcome values. The plot illustrates a relationship between the confidence score generated by a machine learning model in relation to a predictive output and an actual accuracy of the predictive output. Based on the data represented in the plot, the threshold-setting function σ can be defined to output the high and low threshold values. For example, to determine the unknown parameters of the threshold-setting function, random values can be used to initialize the threshold-setting function, e.g., μ*, θ_{H}, θ_{L} such that θ_{L}<μ*<θ_{H} (e.g., 0.3, 0.5, and 0.7 respectively). The random initialization serves as an initial “guess” of the threshold-setting function σ.

The initialized threshold-setting function can be applied to the historical data (e.g., data that includes observations of input values to the machine learning model and observed output values). Based on processing the historical data with the machine learning model, a number of data points of the plot (e.g., the example plot 200 of FIG. 2) can be determined, where a data point is an ordered pair that includes an uncalibrated confidence score from the machine learning model and an observed accuracy of the machine learning model in relation to the historical data. A portion of the data points can be determined to fall in undesirable region(s) of the plot (e.g., corresponding to data points in the regions of 210 and 212). Based on the number of data points that fall in the undesirable region, the values of μ*, θ_{H}, and θ_{L} are iteratively adjusted to minimize the number data points corresponding to the outputs of the machine learning model based on processing the historical data that fall within the undesirable regions. In some instances, an optimization function, e.g., gradient descent, can be applied based on processing the historical data to determine values of μ*, θ_{H}, and θ_{L} that minimize the number of data points (points correspond to a respective uncalibrated confidence score for a prediction and an observed accuracy for that prediction as shown and described in relation to FIG. 2) that fall in the undesired regions. In some instances, the iterative determination of the threshold function variables can be terminated when the ratio of data points that fall in an undesirable regions from all of the data points, as determined for the iteratively determined low threshold value and the high threshold value, reaches a percentage value that is below a threshold percentage, e.g., 10%. In some instances, an interface application 516 can receive a calibrated confidence score 514 from the threshold-setting function 512. In some instances, the interface application 516 includes a user interface. In some instances, the interface application 516 is an application programming interface.

FIG. 6 is a flowchart illustrating an example of a computer-implemented method 600 for providing a calibrated confidence score of a prediction of a machine learning model based on using a threshold-setting function, according to an implementation of the present disclosure. For clarity of presentation, the description that follows generally describes method 600 in the context of the other figures in this description. However, it will be understood that method 600 can be performed, for example, by any system, environment, software, and hardware, or a combination of systems, environments, software, and hardware, as appropriate. For example, the method 600 can be performed at a server of environment 106 of FIG. 1. In some implementations, various steps of method 600 can be run in parallel, in combination, in loops, or in any order.

At 602, the system determines a first confidence score for a prediction generated by a machine learning model. The machine learning model generates predictive outputs and corresponding confidence scores that are to be calibrated.

In some instances, the system receives a request from an application to generate a prediction based on input data, generates (using the machine learning model) the prediction, and generates a confidence score for the prediction.

At 604, the system applies a threshold-setting function to determine a confidence threshold by comparing the determined first confidence score with a reference confidence score, wherein the threshold-setting function determines the confidence threshold to a lower or higher value based on determining whether the reference confidence score is below or above the first confidence score.

In some instances, applying the threshold-setting function includes determining that the reference confidence score is below the reference confidence score and setting the confidence threshold to a calibrated score value below the reference confidence score.

At 606, the system generates a prediction evaluation of the prediction generated by the machine learning model by comparing the first confidence score with the confidence threshold. In some instances, in response to the prediction evaluation, the system generates an instruction to output the prediction as generated by the machine learning model for use during execution of a process flow running at a software application. In some instances, the calibrated confidence score is usable to differentiate between (i) occurrences where an actual output is more accurate compared to a prediction generated by the machine learning model and (ii) occurrence where the actual output is worse than the prediction from the machine learning model.

In contrast to the method 400 that describes a generation of an adjusted confidence score, the method 600 does not result in an adjusted, or calibrated confidence score. In contrast, the method 600 conditionally applies different confidence thresholds to treat uncalibrated confidence scores (e.g., the first confidence score) in a way that achieves an effect similar to generating an adjusted calibration score. For example, consider a case in which the parameters of the threshold-setting function, as described in relation to FIG. 5, are determined to be θ_{L}=0.3, μ*=0.5, and θ_{H}=0.7. An interpretation of these determined parameters is that, according to historical data, uncalibrated confidence scores generated by the machine learning model in relation to particular predictions that are in the range between 0.3 and 0.5 (θ_{L} and μ*) tend to underestimate the actual accuracy of the corresponding predictions. Similarly, uncalibrated confidence scores generated by the machine learning model in relation to particular predictions that are in the range between 0.5 and 0.7 (μ* and θ_{H}) tend to overestimate the actual accuracy of the corresponding predictions.

In some examples, consider a case in which an uncalibrated confidence score (e.g., the first confidence score) is determined to be μ=0.4. Based on the determined parameters of the threshold-setting function described above, μ is less than or equal to μ*, and is thus compared to θ_{L}. Because 0.4 is greater than 0.3 (θ_{L}), it can be determined that the corresponding prediction accuracy is likely to be greater than the determined confidence score suggests (i.e., actual accuracy is greater than 40%). The provided example demonstrates a scenario in which the received uncalibrated confidence score (μ) is treated as if is shifted to the right (compared to a confidence threshold θ_{L}).

In some use cases, an uncalibrated confidence score (e.g., the first confidence score) can be determined to be μ=0.6. Based on the determined parameters of the threshold-setting function described above, μ is greater than μ*, and is thus compared to θ_{H}. Because 0.6 is less than 0.7 (θ_{H}), it can be determined that the corresponding prediction accuracy is likely to be less than the determined confidence score suggests (i.e., actual accuracy less than 60%). The provided example demonstrates a scenario in which the received uncalibrated confidence score (μ) is treated as it is shifted to the left (compared to a confidence threshold θ_{H}).

In some examples, the uncalibrated confidence score (μ) can be less than θ_{L} or greater than θ_{R}. These scenarios correspond to a very low uncalibrated confidence score and a very high uncalibrated confidence score respectively. In these cases, the actual accuracy of the predicted output can be considered to be low and high respectively, although an estimation of a calibrated confidence score is not determined.

In some instances, generating the prediction evaluation of the prediction includes determining to provide an instruction to display the prediction as part of an application or system, in which the machine learning model was requested to generate the prediction based on data from the application or the system.

In some instances, generating the prediction evaluation includes providing the generated prediction together with a label indicative as to whether the prediction is acceptable or unacceptable for input into a process flow executed at a software application. In some instances, the software application is configured to execute the process flow based on obtaining data from a user and generated prediction data for use in the process flow, where the machine learning model is queried to generate the prediction data based on a request received from the software application, wherein the machine learning model is conditioned based on at least a portion of the obtained data from the user during the process flow. In some instances, the software application includes a user interface associated with tabular data objects stored at a respective storage associated with a user interface form, where each data object of the tabular data object corresponds to a respective user interface field of the user interface form, where providing the generated prediction includes displaying the prediction into an associated field on the user interface during executing the process flow associated with the user interface form being processed based on interaction with the user.

In some instances, the system exposes an interface for processing requests for evaluating predictions generated by machine learning models, receives, at the interface, a request to evaluate the prediction generated by the machine learning model, and provides the calibrated confidence score.

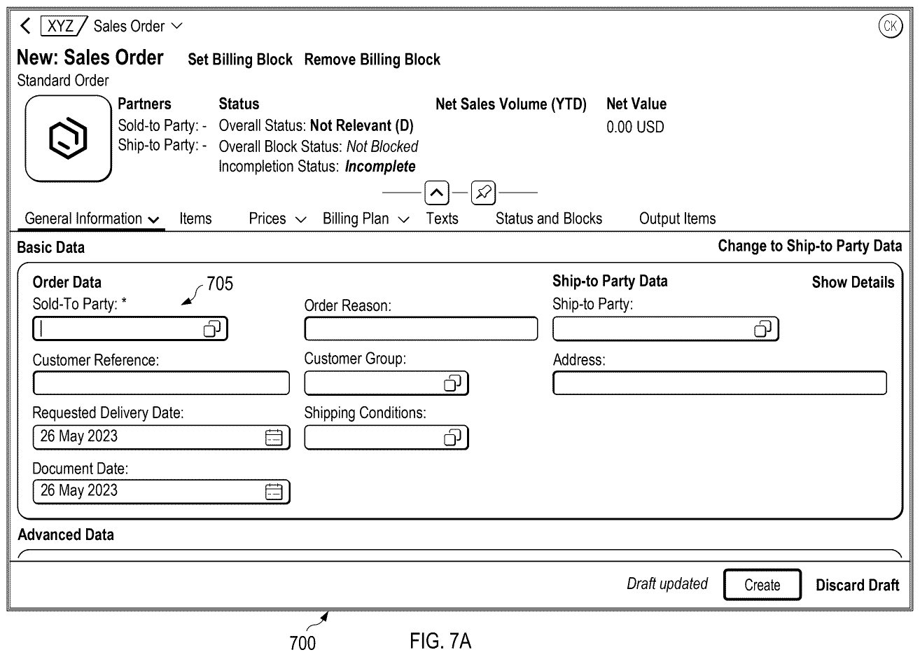

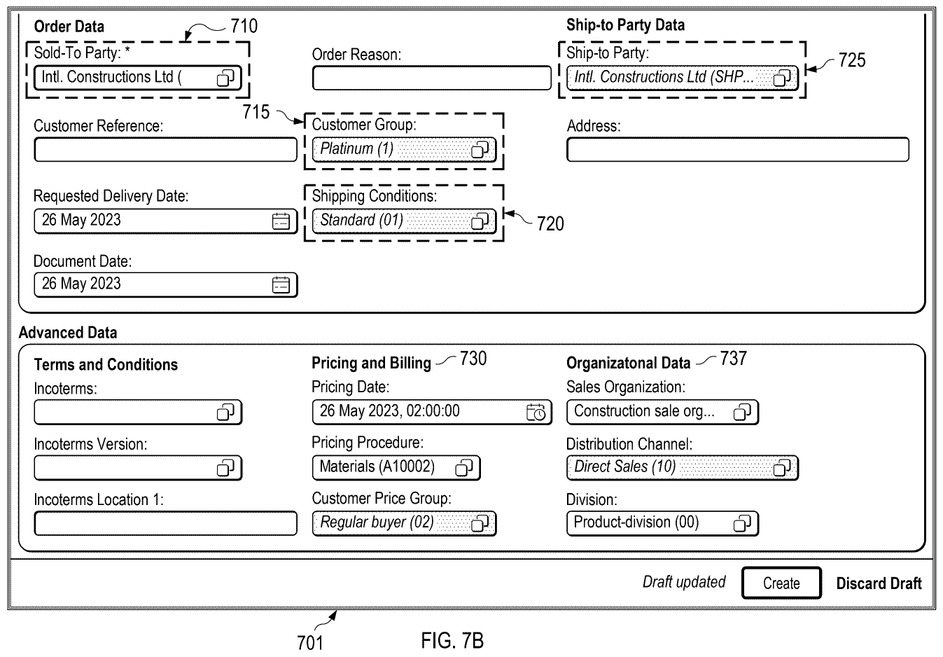

FIG. 7A is a block diagram illustrating an example user interface form 700 provided for user interaction and input of field values at one or more fields, according to an implementation of the present disclosure. The example user interface form 700 is a form provided as part of an application for generating sales orders. The user interface form 700 implements “smart” logic for recommending data entries in the form while a user is entering their input, in form of recommendations in accordance with implementations of the present disclosure. For example, the user interface form 700 can support providing of data imputation based on an output of a trained machine learning model. The trained machine learning model can be trained based on training data specific to an execution context of the application. For example, the training data can include input data and output data specific to fields related to the user interface form 700 and related process flow of generating sales orders.

In some instances, the user interface form 700 can be provided on a user interface for a display device of a user, where the user interface can be provided by an application such as a sales application, when requested to create a new sales order. The sales orders generated through the user interface form 700 can be stored in a tabular data object at a data storage, such as a database. The user interface form 700 can receive user input and can provide recommendation for imputing tabular data in the user interface form 700 so that upon completion of the sales order creation, the data as provided in the user interface form 700 can be stored as a row in a tabular data object defined for the sales order user interface form 700.

The user interface form 700 includes a data field that is “Sold-to Party” 705 field, where a user can provide input to initiate the creation of a sales order. For example, some fields that are part of the user interface form 700 can be automatically populated upon initiation of creation of a sales order, such as a requested delivery date, or a document date. The field values for such fields can be determined automatically based on preconfigured rules. In the example of the requested delivery date and document date field, a rule can be defined to input a current date of creation of the sales order as the field value. The user interface form 700 can include other data fields that are empty, as shown on FIG. 7A, which can be filled in with values based on user interactions. Such user input for data field can trigger invocation of a trained machine learning model, to support the filling in of the sales order and to predict values for fields for which no input was provided as recommendations for the entries that can be confirmed or modified by a user filling in the user interface form 700.

FIG. 7B is a block diagram illustrating an example user interface form 701 for user interaction that implements logic for automatic data imputation based on a trained machine learning model (e.g., the trained machine learning model 204 of FIG. 2), according to an implementation of the present disclosure. The example user interface form 701 can be an updated version of the user interface form 700 that is generated upon input of data by a user to fill in the Sold-to Party 710 field with a field value, such as “Intl. Constructions Ltd.”. In that example, when the user had entered the field value for the Sold-to Party 710, a trained model can be invoked to predict values for one or more other user interface fields of the user interface form 700 based on the first field value for the first field and to provide those predicted values as recommendations for values in the user interface form 701. In the example of the user interface form 701, recommendations based on predicted values for fields Customer Group 715, Shipping Conditions, and Ship-to Party 725 are provided for fields part of the order data section of the user interface form 701. In some cases, other fields of the user interface form 701 can be filled in with recommendations based on predicted values as output by the trained model. The recommended values as provided on the user interface form 701 can be highlighted in a particular color, marked, or otherwise annotated to indicate to the user that such fields are automatically input as recommendations and are not user input data.

In some instances, the user interface form 701 can include labels indicative of the accuracy of the recommendations provided as output by the trained model. A predicted value for the Customer Group 715 field can include the recommend value along with a label indicative of an evaluation metric associated with a machine learning model that outputs the predicted value. In some instances, the label is implemented as a percentage, a colored interface element, or a message to the user.

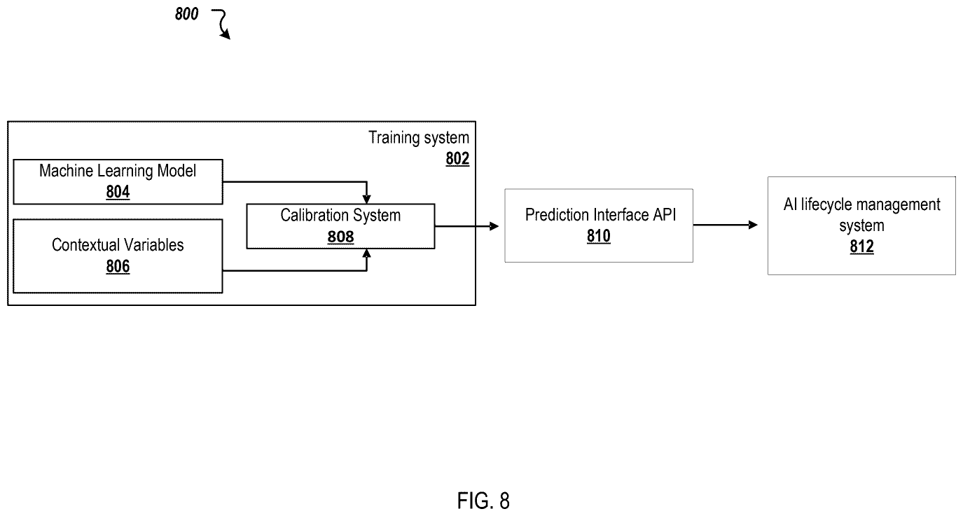

FIG. 8 is a block diagram of an example computer-implemented system 800 for generating a calibrated confidence score of a predictive output of a trained machine learning model. The calibrated confidence score can be provided as an input to an artificial intelligence (AI) lifecycle management system 812 for incorporation into processes of selecting a trained model for use in a particular context, for evaluation of performance of models in a given context, for performing a selection or filtering of trained models for use in contexts associated with one or more computing environment where one or more applications and services can perform processes that can be automated based on model output data. In some instances, by identifying a calibrated confidence score for a predictive output of a trained model to determine whether to use the model in a given context or to use a specific prediction of the model in the given context, the accuracy of the process execution can be improved as well as the computation resources associated with the execution can be more efficiently utilized.

The system 800 includes at least one processor (e.g., a processor of a computing device of the environment 106 or 108 of FIG. 1) that implements operations of one or more machine learning models that generates predictive outputs, machine learning training systems, and other data processing tasks. In a general sense, each system component of FIG. 8 represents one or more computational operations executed by a processor of a system, e.g., system 100, that includes one or more processors (e.g., a processor of a computational device of environment 106 or 108, a processor associated with the client device 102, etc.).

A training system 802 trains a machine learning model 804 to output a predicted value. In the context of the present disclosure, the predicted values can include one or more data fields of a user interface related to a particular process flow of an application. However, the machine learning model 804 trained by the training system 802 is applicable to generating predictive outputs for any application type.

The training system 802 trains the machine learning model 804 based on training data specific to a particular execution context. The execution context is represented by one or more data attributes that represent an implementation of an application, process flow, and/or use case. The training system 802 computes contextual variables 806 related to the training data, where the training data is used by the training system 802 to train the machine learning model 804. The contextual variables 806 can include variables that describe the predictive outputs (e.g., data types, data ranges, categorical variables, etc.) and variables that describe attributes of the training data.

The training system 802 includes a calibration system 808 that applies a calibration to one or more confidence scores associated with a predictive output of the machine learning model 804. For example, the applied calibration can be performed as described in relation to FIG. 3. The confidence score reflects a likelihood that a predictive output generated by the machine learning model 804 is accurate. However, the confidence score does not always correlate with an accuracy of the machine learning model, in which the accuracy reflects a probability of correctness.

A prediction interface application programming interface (API) 810 can receive requests for predictive outputs of the machine learning model 804 as well as associated confidence scores. The API 810 can receive adjusted confidence scores (i.e., calibrated confidence scores) associated with outputs of the machine learning model 804. In some instances, the processors associated with the API 810 are different from the processors that implement the operations of the training system 802.

Based on the adjusted confidence scores (i.e., calibrated confidence scores) as generated by the calibration system 808 and processed by the API 810, a subsequent step of the AI lifecycle management system 812 can be initiated. In some instances, the system 812 compares a calibrated confidence score to a threshold value to determine if a subsequent step is initiated. In some instances, the system 812 compares a calibrated confidence score to a threshold value to determine if the machine learning model 804 is sufficiently accurate to provide outputs to an application. In some instances, the system 812 compares a calibrated confidence score to a threshold value to determine if the machine learning model 804 should be re-trained using new training data, a subset of existing training data, or based on a modified training procedure.

The training system 802 includes the training process of the machine learning model 804 and the calibration process that can include processing the contextual variables 806 and predictive outputs of the machine learning model 804 as part of a common training system 802. In some instances, the operations executed in relation to the machine learning model 804 and the calibration system 808 are performed by one or more processors of a shared infrastructure (training system 802), in which the processors can access common data stores and computational processes. As such, the training system 802 can iteratively modify characteristics (e.g., weights, model architecture, training procedures, etc.) of the machine learning model 804 in response to calibrated evaluation metrics generated by the calibration system 808 to iteratively improve the performance of the trained machine learning model 804.

In some instances, the machine learning model 804 is a generative artificial intelligence (Gen AI) model. As such, in some instances, the training system 802 is a Gen AI fine-tuning system, in which the system 802 fine-tunes a pre-trained large language model (generative AI model). In some instances, the calibration system 808 is accessible to the training system 802 that performs a fine-tuning process on the Gen AI model and can adjust one or more parameters of the fine-tuning data and/or fine-tuning process based on a calibrated confidence score generated by the calibration system 808. In some other instances, the calibration system 808 is not accessible to the training system 802 that performs the fine-tuning process on the Gen AI model, and therefore the calibration system 808 only executes the calibration process on the outputs of the Gen AI model without a possibility for iterative feedback to the parameters of the Gen AI model.

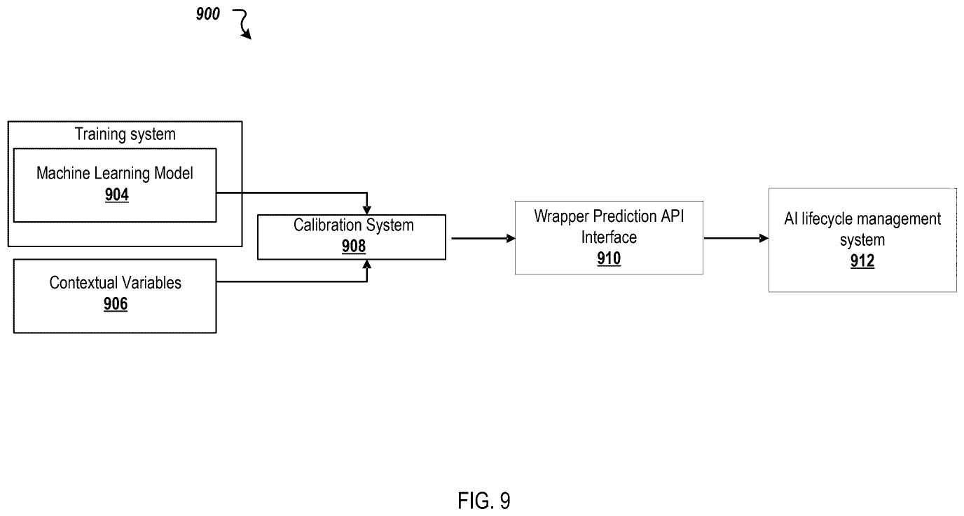

In some instances, a training system does not have access to calibrated confidence scores, as depicted in FIG. 9. FIG. 9 is a block diagram of an example computer-implemented system 900 for generating a calibrated confidence score of a predictive output of a trained machine learning model. The calibrated confidence score is an input to an AI lifecycle management system 912. The system 900 includes at least one processor (e.g., a processor of a computing device of the environment 106 or 108 of FIG. 1) that implements operations of one or more machine learning models that generates predictive outputs, machine learning training systems, and other data processing tasks. In a general sense, each system component of FIG. 9 represents one or more computational operations executed by a processor of a system, e.g., system 100, that includes one or more processors (e.g., a processor of a computational device of environment 106 or 108, a processor associated with the client device 102, etc.).

Similar to the system 800 described in relation to FIG. 8, the training system 902 performs a training process in relation to a machine learning model 904. In some instances, execution of requests for outputs from the trained machine learning model 904 includes a request to provide confidence scores related to the machine learning model and the particular outputs of the machine learning model. As described in relation to the previous figures, confidence scores are indicative of the accuracy of each particular predictive output of the trained machine learning model 904. In some instances, upon receiving a request for a predictive output, the machine learning model 904 outputs the predictive output and performs confidence evaluation to output an associated confidence score in addition to the predictive output.

In contrast to the training system 802, the training system 902 does not access calibrated confidence scores and contextual variables 906 or a calibration system 908. The machine learning model 904 generates a predictive output and an associated confidence scores independent of the contextual variables 906 and without performing a calibration procedure of the calibration system 908.

In the case of the training system 902 not having access to the contextual variables 906 and the calibration system 908, the training system 902 cannot iteratively improve the performance of the machine learning model 904 based on the output of the calibration system 908. In this case, the output of the calibration system 908 is accessed by a wrapper prediction API 910, in which the API 910 provides a calibrated confidence score based on the predictive outputs generated by the machine learning model 904.

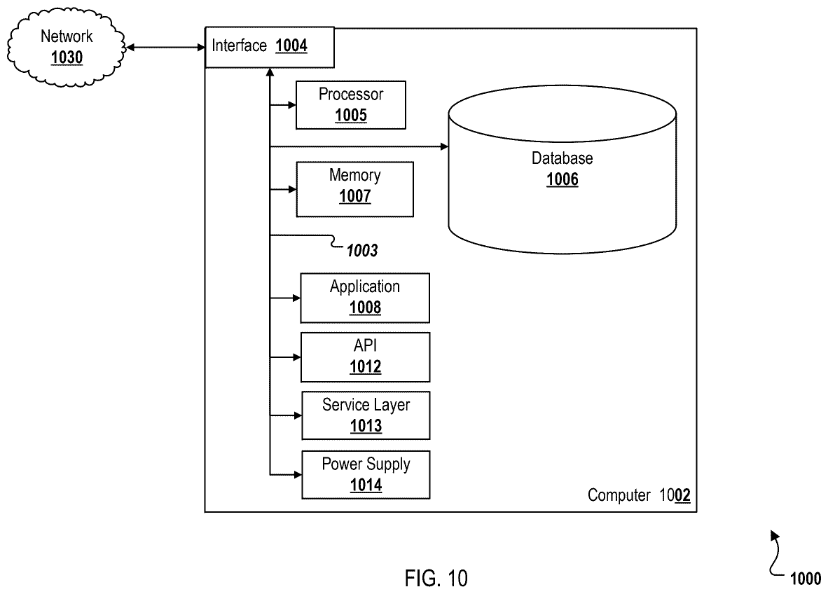

FIG. 10 is a block diagram illustrating an example of a computer-implemented system 1000 used to provide computational functionalities associated with described algorithms, methods, functions, processes, flows, and procedures, according to an implementation of the present disclosure. In the illustrated implementation, computer-implemented system 1000 includes a Computer 1002 and a Network 1030.

The illustrated Computer 1002 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 1002 can include an input device, such as a keypad, keyboard, or touch screen, or a combination of input devices that can accept user information, and an output device that conveys information associated with the operation of the Computer 1002, including digital data, visual, audio, another type of information, or a combination of types of information, on a graphical-type user interface (UI) (or GUI) or other UI.

The Computer 1002 can serve in a role in a distributed computing system as, for example, a client, network component, a server, or a database or another persistency, or a combination of roles for performing the subject matter described in the present disclosure. The illustrated Computer 1002 is communicably coupled with a Network 1030. In some implementations, one or more components of the Computer 1002 can be configured to operate within an environment, or a combination of environments, including cloud-computing, local, or global.

At a high level, the Computer 1002 is an electronic computing device operable to receive, transmit, process, store, or manage data and information associated with the described subject matter. According to some implementations, the Computer 1002 can also include or be communicably coupled with a server, such as an application server, e-mail server, web server, caching server, or streaming data server, or a combination of servers.

The Computer 1002 can receive requests over Network 1030 (for example, from a client software application executing on another Computer 1002) and respond to the received requests by processing the received requests using a software application or a combination of software applications. In addition, requests can also be sent to the Computer 1002 from internal users (for example, from a command console or by another internal access method), external or third-parties, or other entities, individuals, systems, or computers.

Each of the components of the Computer 1002 can communicate using a System Bus 1003. In some implementations, any or all of the components of the Computer 1002, including hardware, software, or a combination of hardware and software, can interface over the System Bus 1003 using an application programming interface (API) 1012, a Service Layer 1013, or a combination of the API 1012 and Service Layer 1013. The API 1012 can include specifications for routines, data structures, and object classes. The API 1012 can be either computer-language independent or dependent and refer to a complete interface, a single function, or even a set of APIs. The Service Layer 1013 provides software services to the Computer 1002 or other components (whether illustrated or not) that are communicably coupled to the Computer 1002. The functionality of the Computer 1002 can be accessible for all service consumers using the Service Layer 1013. Software services, such as those provided by the Service Layer 1013, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 1002, alternative implementations can illustrate the API 1012 or the Service Layer 1013 as stand-alone components in relation to other components of the Computer 1002 or other components (whether illustrated or not) that are communicably coupled to the Computer 1002. Moreover, any or all parts of the API 1012 or the Service Layer 1013 can be implemented as a child or a sub-module of another software module, enterprise application, or hardware module without departing from the scope of the present disclosure.

The Computer 1002 includes an Interface 1004. Although illustrated as a single Interface 1004, two or more Interfaces 1004 can be used according to particular needs, desires, or particular implementations of the Computer 1002. The Interface 1004 is used by the Computer 1002 for communicating with another computing system (whether illustrated or not) that is communicatively linked to the Network 1030 in a distributed environment. Generally, the Interface 1004 is operable to communicate with the Network 1030 and includes logic encoded in software, hardware, or a combination of software and hardware. More specifically, the Interface 1004 can include software supporting one or more communication protocols associated with communications such that the Network 1030 or hardware of Interface 1004 is operable to communicate physical signals within and outside of the illustrated Computer 1002.

The Computer 1002 includes a Processor 1005. Although illustrated as a single Processor 1005, two or more Processors 1005 can be used according to particular needs, desires, or particular implementations of the Computer 1002. Generally, the Processor 1005 executes instructions and manipulates data to perform the operations of the Computer 1002 and any algorithms, methods, functions, processes, flows, and procedures as described in the present disclosure.

The Computer 1002 also includes a Database 1006 that can hold data for the Computer 1002, another component communicatively linked to the Network 1030 (whether illustrated or not), or a combination of the Computer 1002 and another component. For example, Database 1006 can be an in-memory or conventional database storing data consistent with the present disclosure. In some implementations, Database 1006 can be a combination of two or more different database types (for example, a hybrid in-memory and conventional database) according to particular needs, desires, or particular implementations of the Computer 1002 and the described functionality. Although illustrated as a single Database 1006, two or more databases of similar or differing types can be used according to particular needs, desires, or particular implementations of the Computer 1002 and the described functionality. While Database 1006 is illustrated as an integral component of the Computer 1002, in alternative implementations, Database 1006 can be external to the Computer 1002. The Database 1006 can hold and operate on at least any data type mentioned or any data type consistent with this disclosure.

The Computer 1002 also includes a Memory 1007 that can hold data for the Computer 1002, another component or components communicatively linked to the Network 1030 (whether illustrated or not), or a combination of the Computer 1002 and another component. Memory 1007 can store any data consistent with the present disclosure. In some implementations, Memory 1007 can be a combination of two or more different types of memory (for example, a combination of semiconductor and magnetic storage) according to particular needs, desires, or particular implementations of the Computer 1002 and the described functionality. Although illustrated as a single Memory 1007, two or more Memories 1007 or similar or differing types can be used according to particular needs, desires, or particular implementations of the Computer 1002 and the described functionality. While Memory 1007 is illustrated as an integral component of the Computer 1002, in alternative implementations, Memory 1007 can be external to the Computer 1002.

The Application 1008 is an algorithmic software engine providing functionality according to particular needs, desires, or particular implementations of the Computer 1002, particularly with respect to functionality described in the present disclosure. For example, Application 1008 can serve as one or more components, modules, or applications. Further, although illustrated as a single Application 1008, the Application 1008 can be implemented as multiple Applications 1008 on the Computer 1002. In addition, although illustrated as integral to the Computer 1002, in alternative implementations, the Application 1008 can be external to the Computer 1002.

The Computer 1002 can also include a Power Supply 1014. The Power Supply 1014 can include a rechargeable or non-rechargeable battery that can be configured to be either user- or non-user-replaceable. In some implementations, the Power Supply 1014 can include power-conversion or management circuits (including recharging, standby, or another power management functionality). In some implementations, the Power Supply 1014 can include a power plug to allow the Computer 1002 to be plugged into a wall socket or another power source to, for example, power the Computer 1002 or recharge a rechargeable battery.

There can be any number of Computers 1002 associated with, or external to, a computer system containing Computer 1002, each Computer 1002 communicating over Network 1030. Further, the term “client,” “user,” or other appropriate terminology can be used interchangeably, as appropriate, without departing from the scope of the present disclosure. Moreover, the present disclosure contemplates that many users can use one Computer 1002, or that one user can use multiple computers 1002.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near (ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a graphics processing unit (GPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, a GPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

### EXAMPLES

Although the present application is defined in the attached claims, it should be understood that the present invention can also be (alternatively) defined in accordance with the following examples:

### Calibrating Confidence Scores of Predictive Outputs Based on a Composite Function

Example 1. A computer-implemented method for calibrating model confidence scores, the method comprising:
providing a set of input datasets to a machine learning model to generate a set of predictions for each input dataset;
determining a set of actual observations associated with the set of generated predictions for the set of input datasets, wherein each of the set of generated predictions is associated with a corresponding confidence score;
generating a calibration plot for performance accuracy of the machine learning model based on the set of input datasets, wherein the calibration plot maps i) a confidence score for a prediction to ii) a correspond model accuracy corresponding to the prediction as determined based on an actual observation of the set of actual observation;
deriving, based on the calibration plot, a best-fit function to predict model accuracy of the machine learning model as a function of confidence scores;
generating a composite function to generate an adjusted confidence score for the machine learning model based on a model confidence score of the machine learning model and the predicted model accuracy of the machine learning model; and
evaluating a prediction generated by the machine learning model by comparing a confidence score generated for the prediction with the adjusted confidence score.

Example 2. The method of Example 1, the method comprising:
providing instruction whether to output the prediction as generated by the machine learning model.

Example 3. The method of Example 2, wherein providing the instruction comprises:
providing the generated prediction together with a label indicative as to whether the prediction is acceptable or unacceptable for input into a process flow executed at a software application.

Example 4. The method of Example 3, wherein the software application is configured to execute the process flow based on obtaining data from a user and generated prediction data for use in the process flow, wherein the machine learning model is queried to generate the prediction data based on a request received from the software application, the machine learning model being conditioned based on at least a portion of the obtained data from the user during the process flow.

Example 5. The method of Examples 3 or 4, wherein the software application includes a user interface associated with tabular data objects stored at a respective storage associated with a user interface form, wherein each data object of the tabular data object corresponds to a respective user interface field of the user interface form, wherein providing the instruction comprises:
in response to determining that the confidence score generated for the prediction is above a threshold score, displaying the prediction into an associated field on the user interface form during executing the process flow.

Example 6. The method of any one of the preceding Examples, wherein the model accuracy for a given input dataset is defined as a difference between i) an actual observation of the set of actual observations for the given input dataset and ii) the prediction generated based on the given input dataset.

Example 7. The method of any one of the preceding Examples, wherein generating the calibration plot comprises:
deriving a prediction model that generated the prediction for the model accuracy based on the confidence score.

Example 8. The method of Example 7, the method comprising:
obtaining contextual data associated with training the machine learning model to generate predictions,
wherein the prediction model generates the prediction for the model accuracy based on the confidence score and the contextual data.

Example 9. The method of Example 8, wherein the contextual data comprises customer specific training data.

Example 10. The method of any one of the preceding Examples, comprising:
exposing an interface to processing requests for evaluating predictions generated by the machine learning model;
receiving, at the interface, a request to evaluate a new prediction generated by the machine learning model; and
providing the adjusted confidence score associated with the new prediction.

Example 11. A non-transitory, computer-readable medium storing one or more instructions executable by a computer system to perform one or more operations according to the method of any one of Examples 1 to 10.

Example 12. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations according to the method of any one of Examples 1 to 10.

### Calibrating Confidence Scores of Predictive Outputs Based on a Threshold Function

Example 1. A computer-implemented method for calibrating model confidence scores, the method comprising:
determining a first confidence score for a prediction generated by a machine learning model;
applying a threshold-setting function to determine a confidence threshold by comparing the determined first confidence score with a reference confidence score of the machine learning model, wherein the threshold-setting function determines the confidence threshold to a lower or higher value based on determining whether the reference confidence score is below or above the first confidence score; and
generating a prediction evaluation of the prediction generated by the machine learning model by comparing the first confidence score with the confidence threshold.

Example 2. The method of Example 1, the method comprising:
in response to the prediction evaluation, generating an instruction to output the prediction as generated by the machine learning model for use during execution of a process flow running at a software application.

Example 3. The method of any one of the preceding examples, wherein the confidence threshold is usable to differentiate between (i) occurrences where an actual output is more accurate compared to a prediction generated by the machine learning model and (ii) occurrences where the actual output is worse than the prediction from the machine learning model.

Example 4. The method of any one of the preceding examples, wherein generating the prediction evaluation of the prediction comprises:
determining to provide an instruction to display the prediction as part of an application or system, wherein the machine learning model was requested to generate the prediction based on data from the application or the system.

Example 5. The method of any one of the preceding examples, comprising:
receiving a request from an application to generate a prediction based on input data; and
generating, using the machine learning model, the prediction,
wherein applying the threshold-setting function comprises generating the confidence threshold for the prediction to be provided for generating the prediction evaluation.

Example 6. The method of example 5, wherein applying the generating the confidence threshold comprises:
determining that the first confidence score is below the reference confidence score; and
setting the confidence threshold to a value below the reference confidence score.

Example 7. The method of any one of the preceding examples, wherein generating the prediction evaluation comprises:
providing the generated prediction together with a label indicative as to whether the prediction is acceptable or unacceptable for input into a process flow executed at a software application, wherein the label is generated based on the generated prediction evaluation, and wherein the prediction is determined to be i) acceptable when the first confidence score is above the determined confidence threshold and ii) unacceptable when the first confidence score is below the determined confidence threshold.

Example 8. The method of example 7, wherein the software application is configured to execute the process flow based on obtaining data from a user and the generated prediction evaluation, wherein the machine learning model is queried to generate the prediction based on a request received from the software application, wherein the machine learning model is conditioned based on at least a portion of the obtained data from the user at the software application.

Example 9. The method of example 7, wherein the software application includes a user interface associated with tabular data objects stored at a respective storage associated with a user interface form, wherein each data object of the tabular data objects corresponds to a respective user interface field of the user interface form, wherein providing the generated prediction comprises:
displaying the prediction into an associated field on the user interface during executing the process flow associated with the user interface form being processed based on interaction with the user.

Example 10. The method of any one of the preceding examples, comprising:
exposing an interface for processing requests for evaluating predictions generated by machine learning models;
receiving, at the interface, a request to evaluate the prediction generated by the machine learning model; and
providing the prediction evaluation.

Example 11. A non-transitory, computer-readable medium storing one or more instructions executable by a computer system to perform one or more operations according to the method of any one of Examples 1 to 10.

Example 12. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations according to the method of any one of Examples 1 to 10.

1. A computer-implemented method for calibrating model confidence scores, the method comprising:
determining a first confidence score for a prediction generated by a machine learning model;
applying a threshold-setting function to determine a confidence threshold by comparing the determined first confidence score with a reference confidence score of the machine learning model, wherein the threshold-setting function determines the confidence threshold to a lower or higher value based on determining whether the reference confidence score is below or above the first confidence score; and
generating a prediction evaluation of the prediction generated by the machine learning model by comparing the first confidence score with the confidence threshold.

2. The method of claim 1, the method comprising:
in response to the prediction evaluation, generating an instruction to output the prediction as generated by the machine learning model for use during execution of a process flow running at a software application.

3. The method of claim 1, wherein the confidence threshold is usable to differentiate between (i) occurrences where an actual output is more accurate compared to a prediction generated by the machine learning model and (ii) occurrences where the actual output is worse than the prediction from the machine learning model.

4. The method of claim 1, wherein generating the prediction evaluation of the prediction comprises:
determining to provide an instruction to display the prediction as part of an application or system, wherein the machine learning model was requested to generate the prediction based on data from the application or the system.

5. The method of claim 1, comprising:
receiving a request from an application to generate a prediction based on input data; and
generating, using the machine learning model, the prediction, and
wherein applying the threshold-setting function comprises generating the confidence threshold for the prediction to be provided for generating the prediction evaluation.

6. The method of claim 1, wherein applying the generating the confidence threshold comprises:
determining that the first confidence score is below the reference confidence score; and
setting the confidence threshold to a value below the reference confidence score.

7. The method of claim 1, wherein generating the prediction evaluation comprises:
providing the generated prediction evaluation together with a label indicative as to whether the prediction is acceptable or unacceptable for input into a process flow executed at a software application, wherein the label is generated based on the prediction evaluation, and wherein the prediction is determined to be i) acceptable when the first confidence score is above the determined confidence threshold and ii) unacceptable when the first confidence score is below the determined confidence threshold.

8. The method of claim 7, wherein the software application is configured to execute the process flow based on obtaining data from a user and the prediction evaluation, wherein the machine learning model is queried to generate the prediction based on a request received from the software application, wherein the machine learning model is conditioned based on at least a portion of the obtained data from the user at the software application.

9. The method of claim 7, wherein the software application includes a user interface associated with tabular data objects stored at a respective storage associated with a user interface form, wherein each data object of the tabular data objects corresponds to a respective user interface field of the user interface form, wherein providing the generated prediction evaluation comprises:
displaying the prediction into an associated field on the user interface during executing the process flow associated with the user interface form being processed based on interaction with the user.

10. The method of claim 1, comprising:
exposing an interface for processing requests for evaluating predictions generated by machine learning models;
receiving, at the interface, a request to evaluate the prediction generated by the machine learning model; and
providing the prediction evaluation.

11. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
determining a first confidence score for a prediction generated by a machine learning model;
applying a threshold-setting function to determine a confidence threshold by comparing the determined first confidence score with a reference confidence score of the machine learning model, wherein the threshold-setting function determines the confidence threshold to a lower or higher value based on determining whether the reference confidence score is below or above the first confidence score; and
generating a prediction evaluation of the prediction generated by the machine learning model by comparing the first confidence score with the confidence threshold.

12. The system of claim 11, wherein the machine-readable media stores further instructions, which when executed by the one or more computers are configured to perform operations comprising:
in response to the prediction evaluation, generating an instruction to output the prediction as generated by the machine learning model for use during execution of a process flow running at a software application.

13. The system of claim 11, wherein the confidence threshold is usable to differentiate between (i) occurrences where an actual output is more accurate compared to a prediction generated by the machine learning model and (ii) occurrences where the actual output is worse than the prediction from the machine learning model.

14. The system of claim 11, wherein generating the prediction evaluation of the prediction comprises:
determining to provide an instruction to display the prediction as part of an application or system, wherein the machine learning model was requested to generate the prediction based on data from the application or the system.

15. The system of claim 11, wherein the machine-readable media stores further instructions, which when executed by the one or more computers are configured to perform operations comprising:
receiving a request from an application to generate a prediction based on input data; and
generating, using the machine learning model, the prediction, and
wherein applying the threshold-setting function comprises generating the confidence threshold for the prediction to be provided for generating the prediction evaluation.

16. The system of claim 11, wherein applying the generating the confidence threshold comprises:
determining that the first confidence score is below the reference confidence score; and
setting the confidence threshold to a value below the reference confidence score.

17. The system of claim 11, wherein generating the prediction evaluation comprises:
providing the generated prediction evaluation together with a label indicative as to whether the prediction is acceptable or unacceptable for input into a process flow executed at a software application, wherein the label is generated based on the prediction evaluation, and wherein the prediction is determined to be i) acceptable when the first confidence score is above the determined confidence threshold and ii) unacceptable when the first confidence score is below the determined confidence threshold.

18. The system of claim 17, wherein the software application includes a user interface associated with tabular data objects stored at a respective storage associated with a user interface form, wherein each data object of the tabular data objects corresponds to a respective user interface field of the user interface form, wherein providing the generated prediction evaluation comprises:
displaying the prediction into an associated field on the user interface during executing the process flow associated with the user interface form being processed based on interaction with the user.

19. The system of claim 11, wherein the machine-readable media stores further instructions, which when executed by the one or more computers are configured to perform operations comprising:
exposing an interface for processing requests for evaluating predictions generated by machine learning models;
receiving, at the interface, a request to evaluate the prediction generated by the machine learning model; and
providing the prediction evaluation.

20. A non-transitory, computer-readable medium storing one or more instructions executable by a computer system to perform one or more operations, comprising:
determining a first confidence score for a prediction generated by a machine learning model;
applying a threshold-setting function to determine a confidence threshold by comparing the determined first confidence score with a reference confidence score of the machine learning model, wherein the threshold-setting function determines the confidence threshold to a lower or higher value based on determining whether the reference confidence score is below or above the first confidence score; and
generating a prediction evaluation of the prediction generated by the machine learning model by comparing the first confidence score with the confidence threshold.
